(19) United States
(12) Patent Application Publication
(10) Pub. No.: US 2015/0093679 A1
(43) Pub. Date: Apr. 2, 2015

(54) FUEL CELL AND SEPARATOR

(71) Applicant: BROTHER KOGYO KABUSHIKI KAISHA, Nagoya-shi (JP)

(72) Inventor: Atsuki Ikoma, Okazaki-shi (JP)

(73) Assignee: BROTHER KOGYO KABUSHIKI KAISHA, Nagoya-shi (JP)

(21) Appl. No.: 14/228,711

(22) Filed: Mar. 28, 2014

(30) Foreign Application Priority Data
Sep. 30, 2013 (JP) 2013-205786
Feb. 28, 2014 (JP) 2014-038027

(51) Int. Cl. H01M 8/02

(52) U.S. Cl. CPC H01M 8/026; H01M 8/0276; H01M 2008/1095
USPC 429/480

(57) ABSTRACT

A separator of a fuel cell may comprise: a first groove portion formed between a first hole and a second hole on a first surface of the separator; a second groove portion formed between a third hole and a fourth hole on a second surface of the separator; a first protrusion portion formed on the first surface and surrounding the first groove portion and the first, second, third and fourth holes; a second protrusion portion formed on the second surface and surrounding the second groove portion and the first, second, third and fourth holes; and third protrusion portions formed between fifth holes and an edge of the separator on the first and second surfaces, the fifth holes being formed between the edge of the separator and an area corresponding to a region surrounded by the first protrusion portion and a region surrounded by the second protrusion portion.

### CROSS-REFERENCE TO RELATED APPLICATIONS

This non-provisional application claims priority under 35 U.S.C. §1.19(a) on Patent Application No. 2013-205786 filed in Japan on Sep. 30, 2013 and Patent Application No. 2014-038027 filed in Japan on Feb. 28, 2014, the entire contents of which are hereby incorporated by reference.

### TECHNICAL FIELD

The present disclosure relates to a fuel cell. Particularly, the disclosure relates to a fuel cell capable of preventing a gasket from sticking to an assembling shaft used in assembling the fuel cell.

### BACKGROUND

In general, in a fuel cell, both surfaces of a membrane electrode assembly (MEA) are held by a pair of separators. Gaskets are interposed between the pair of separators and the membrane electrode assembly, respectively. The gaskets, membrane electrode assembly and pair of separators constitute a unit cell. The general fuel cell has a structure in which the unit cells are stacked. A stacked body of the unit cells is generally referred to as a stack.

Among component parts of the fuel cell, the membrane electrode assembly has a cathode electrode and an anode electrode disposed on both surfaces of a solid polymer electrolyte membrane. For example, the fuel cell is a polymer electrolyte fuel cell including a polymer electrolyte membrane. Each of these cathode electrode and anode electrode has a catalyst layer and a gas diffusion layer.

Meanwhile, among the component parts of the polymer electrolyte fuel cell, the separator is made of a plate-shaped member having conductivity. A plurality of flow path walls are formed on one surface of the separator. The plurality of flow path walls are flow path walls for causing an oxidizing gas to flow between the one surface of the separator and the cathode electrode. A plurality of flow path walls are also formed on the other surface of the separator. The plurality of flow path walls are flow path walls for causing a fuel gas to flow between the other surface and the anode electrode. Holes serving as a gas introduction path and a gas discharge path are formed at both ends of the flow path walls, respectively. The holes respectively formed at both ends of the flow path walls communicate among the plurality of unit cells when the stack is configured. This results in a series of gas introduction path and a series of gas discharge path at both ends of the flow paths of the unit cells.

The fuel gas supplied to the membrane electrode assembly is diffused by the diffusion layer of the anode electrode and decomposed into a hydrogen ion and an electron by the catalyst layer. The hydrogen ion passes through the solid polymer electrolyte membrane to the cathode electrode, and the electron passes through the separator, which is a conductor, to the cathode electrode. The cathode electrode causes the hydrogen ion and the electron to react with the oxidizing gas supplied through the flow path of the separator to generate water. Here, electricity is generated by a reverse principle of electrolysis of water.

Here, when the stack is assembled, the plurality of separators and gaskets, and membrane electrode assemblies constituting the respective unit cells should be precisely positioned. Conventionally, assembling shafts are used to position the component parts of the respective unit cells. For example, in a conventional method, a plurality of insertion holes are provided in a separator, a resin frame and a seal material, respectively. There is disclosed a method of positioning component parts of respective unit cells by inserting assembling shafts into these insertion holes.

### SUMMARY

A thin sheet material generally formed of rubber or an elastomer is used in the gasket that constitutes the stack. When the component parts of the stack are stacked, the gasket and the separator come in partial contact with each other to cause sealing. The sealing prevents the fuel gas, the oxidizing gas, or water from leaking outside the unit cell. However, in the conventional method using the assembling shafts, after the component parts of the respective unit cells are stacked, when the assembling shafts are pulled out of the insertion holes, a part of the gasket may be stuck to the assembling shaft.

Sticking of the gasket to the assembling shaft may move the gasket, or may damage the gasket. In this case, sealability of the unit cell is deteriorated, which poses a problem that the fuel gas, the oxidizing gas or water leaks from the inside to the outside of the unit cell.

The present disclosure has been made in consideration of these problems, and an object thereof is to provide a fuel cell and a separator capable of preventing a gasket from sticking to an assembling shaft.

In order to accomplish the object, the fuel cell of the present disclosure is that a fuel cell may comprise: a membrane electrode assembly having a planar shape; a separator having a planar shape and provided on each of both surfaces of the membrane electrode assembly, the separator comprising: a first groove portion formed between a first hole being pierced in the separator and a second hole being pierced in the separator on a first surface of the separator; a second groove portion formed between a third hole being pierced in the separator and a fourth hole being pierced in the separator on a second surface of the separator; a first protrusion portion formed on the first surface, the first protrusion portion surrounding the first groove portion, the first hole, the second hole, the third hole, and the fourth hole; a second protrusion portion formed on the second surface, the second protrusion portion surrounding the second groove portion, the first hole, the second hole, the third hole, and the fourth hole; and a plurality of third protrusion portions formed between a plurality of fifth holes and an edge of the separator on each of the first surface and the second surface, the plurality of fifth holes being pierced in the separator between the edge of the separator and an area, the area corresponding to a region surrounded by the first protrusion portion on the separator and a region surrounded by the second protrusion portion on the separator; and a gasket provided between the membrane electrode assembly and the separator, the gasket being formed with a through-hole being pierced in the gasket at a position corresponding to the first groove portion and the second groove portion, and through-holes being pierced in the gasket at positions corresponding to the first hole, the second hole, the third hole, the fourth hole, and the plurality of fifth holes, respectively.

Moreover, in order to accomplish the object, the separator of the present disclosure is that a separator having a planar shape to be provided on each of both surfaces of a membrane electrode assembly having a planar shape, the separator may comprise: a first groove portion formed between a first hole being pierced in the separator and a second hole being pierced in the separator on a first surface of the separator; a second groove portion formed between a third hole being pierced in the separator and a fourth hole being pierced in the separator on a second surface of the separator; a first protrusion portion formed on the first surface, the first protrusion portion surrounding the first groove portion, the first hole, the second hole, the third hole, and the fourth hole; a second protrusion portion formed on the second surface, the second protrusion portion surrounding the second groove portion, the first hole, the second hole, the third hole, and the fourth hole; and a plurality of third protrusion portions formed between a plurality of fifth holes and an edge of the separator on each of the first surface and the second surface, the plurality of fifth holes being pierced in the separator between the edge of the separator and an area, the area corresponding to a region surrounded by the first protrusion portion on the separator and a region surrounded by the second protrusion portion on the separator.

Furthermore, in order to accomplish the object, the fuel cell of the present disclosure is that a fuel cell may comprise: a membrane electrode assembly having a planar shape; a first separator having a planar shape and provided on one surface of the membrane electrode assembly, the first separator comprising: a first groove portion formed between a first hole being pierced in the first separator and a second hole being pierced in the first separator on a first surface opposed to the membrane electrode assembly; and a first protrusion portion formed on the first surface, the first protrusion surrounding the first groove portion, the first hole, and the second hole; and a second separator having a planar shape and provided on another surface of the membrane electrode assembly, the second separator comprising: a second groove portion formed between a third hole being pierced in the second separator and a fourth hole being pierced in the second separator on a second surface opposed to the membrane electrode assembly; and a second protrusion portion formed on the second surface, the second protrusion portion surrounding the second groove portion, the third hole, and the fourth hole, wherein the first separator comprises a plurality of third protrusion portions formed between a plurality of fifth holes and an edge of the first separator on the first surface, the plurality of fifth holes being pierced in the first separator between the edge of the first separator and a region surrounded by the first protrusion portion, the second separator comprises a plurality of fourth protrusion portions formed between a plurality of sixth holes and an edge of the second separator on the second surface, the plurality of sixth holes being pierced in the second separator between the edge of the second separator and a region surrounded by the second protrusion portion, and the fuel cell further comprises: a first gasket provided between the membrane electrode assembly and the first separator, the first gasket being formed with through-holes being pierced in the first gasket at positions corresponding to the first groove portion, the first hole, the second hole, and the plurality of fifth holes, respectively; and a second gasket provided between the membrane electrode assembly and the second separator, the second gasket being formed with through-holes being pierced in the second gasket at positions corresponding to the second groove portion, the third hole, the fourth hole, and the plurality of sixth holes, respectively.

According to the fuel cell and the separator of the present disclosure, the gasket can be prevented from sticking to the assembling shafts, so that damage of the gasket can be prevented.

The above and further objects and features will more fully be apparent from the following detailed description of preferred embodiments with reference to accompanying drawings.

### BRIEF DESCRIPTION OF THE SEVERAL VIEWS OF THE DRAWINGS

FIG. 1 is a perspective view showing a polymer electrolyte fuel cell according to an embodiment.

FIG. 2 is an exploded perspective view showing a structure of a stack 1A of the polymer electrolyte fuel cell.

FIG. 3 is a plan view of a separator 10 when seen from a back direction.

FIG. 4 is an exploded perspective view for describing an assembling process of the stack 1A.

FIG. 5A is a plan view of the separator 10 when seen from a front direction.

FIG. 5B is a plan view of a gasket when seen from the back direction.

FIG. 6 is a plan view when a gasket line 18 formed in the separator 10 is seen from the back direction.

FIG. 7A is a partial cross-sectional view and a partially enlarged view of the separator 10.

FIG. 7B is a partial cross-sectional view showing a stacked state of the separators 10 and the gaskets 20.

FIG. 8A is plan views showing variations of a protrusion provided in the separator 10 and/or the gasket 20.

FIG. 8B is plan views showing variations of a protrusion provided in the separator 10 and/or the gasket 20.

FIG. 8C is plan views showing variations of a protrusion provided in the separator 10 and/or the gasket 20.

FIG. 8D is plan views showing variations of a protrusion provided in the separator 10 and/or the gasket 20.

FIG. 8E is plan views showing variations of a protrusion provided in the separator 10 and/or the gasket 20.

FIG. 8F is plan views showing variations of a protrusion provided in the separator 10 and/or the gasket 20.

FIG. 8G is plan views showing variations of a protrusion provided in the separator 10 and/or the gasket 20.

FIG. 8H is plan views showing variations of a protrusion provided in the separator 10 and/or the gasket 20.

### DETAILED DESCRIPTION

Hereinafter, a polymer electrolyte fuel cell, a separator and a gasket that constitute the same according to an embodiment of the present disclosure will be described with reference to the drawings.

### <Entire Structure>

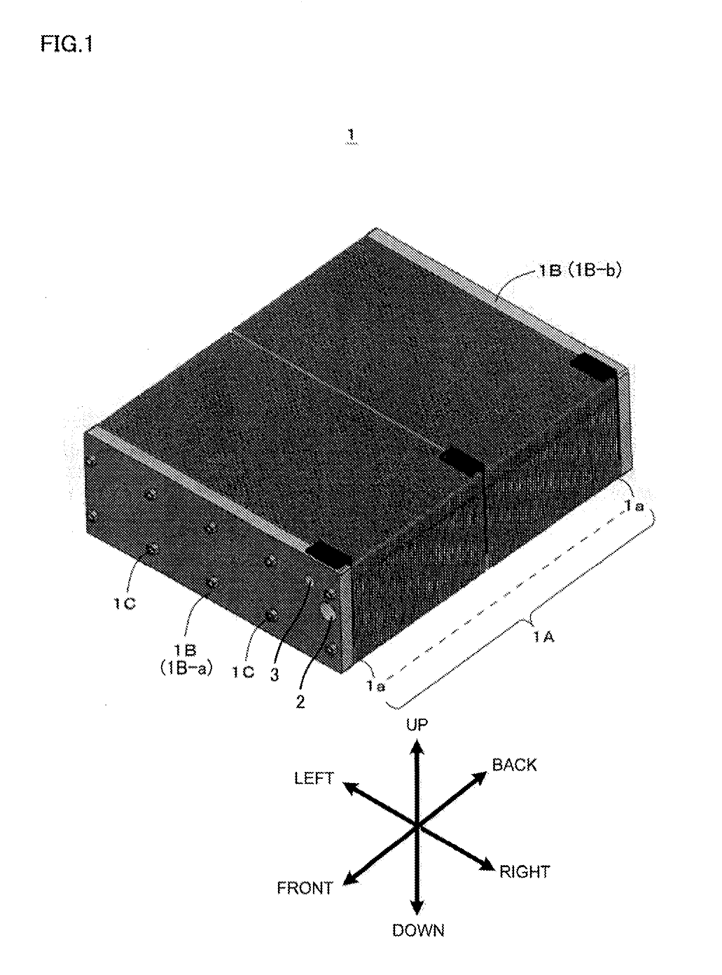

In FIG. 1, a polymer electrolyte fuel cell 1 of the embodiment comprises a stack 1A, a pair of end plates 1B, and a plurality of bolts 1C. The stack 1A includes a plurality of unit cells 1a stacked on one another. The pair of end plates 1B each has a rectangular planer shape. The plurality of unit cells 1a are stacked along a front-and-back direction, as shown in FIG. 1. The front-and-back direction is a direction in which the plurality of unit cells 1a are stacked. Moreover, as shown in FIG. 1, a long-side direction of the rectangle constituting each of the pair of end plates 1B is a right-and-left direction, and a short-side direction of the rectangle constituting each of the pair of the end plates 1B is an upper-and-lower direction. The pair of end plates 1B holds both ends of the stack 1A in the front-and-back direction. The plurality of bolts 1C fix the stack 1A and the pair of end plates 1B to each other. Some of the plurality of bolts 1C pass through either of the pair of end plates 1B to fix either of the pair of end plates 1B and the stack 1A to each other. Moreover, the rest of the plurality of bolts 1C pass through both the pair of end plates 1B to fix the pair of the end plates 1B and the stack 1A.

As shown in FIG. 1, in one end plate 1B-a of the pair of end plates, a first gas hole 2 is formed. Furthermore, as shown in FIG. 1, a second gas hole 3 is formed in the end plate 1B-a. Moreover, in another end plate 1B-b of the pair of end plates, a third gas hole (not shown) is formed. Furthermore, in the end plate 1B-b, a fourth gas hole (not shown) is formed. The first gas hole 2 is formed at one end of the end plate 1B-a along the right-and-left direction, and the first gas hole 2 and the second gas hole 3 are formed at different positions in the end plate 1B-a. Moreover, the third gas hole is formed at the other end of the end plate 1B-b along the right-and-left direction, and the third gas hole and the fourth gas hole are formed at different positions in the end plate 1B-b. The first gas hole 2 and the second gas hole 3 are through-holes that are pierced in the end plate 1B-a. Similarly, the third gas hole and the fourth gas hole are also through-holes that are pierced in the end plate 1B-b.

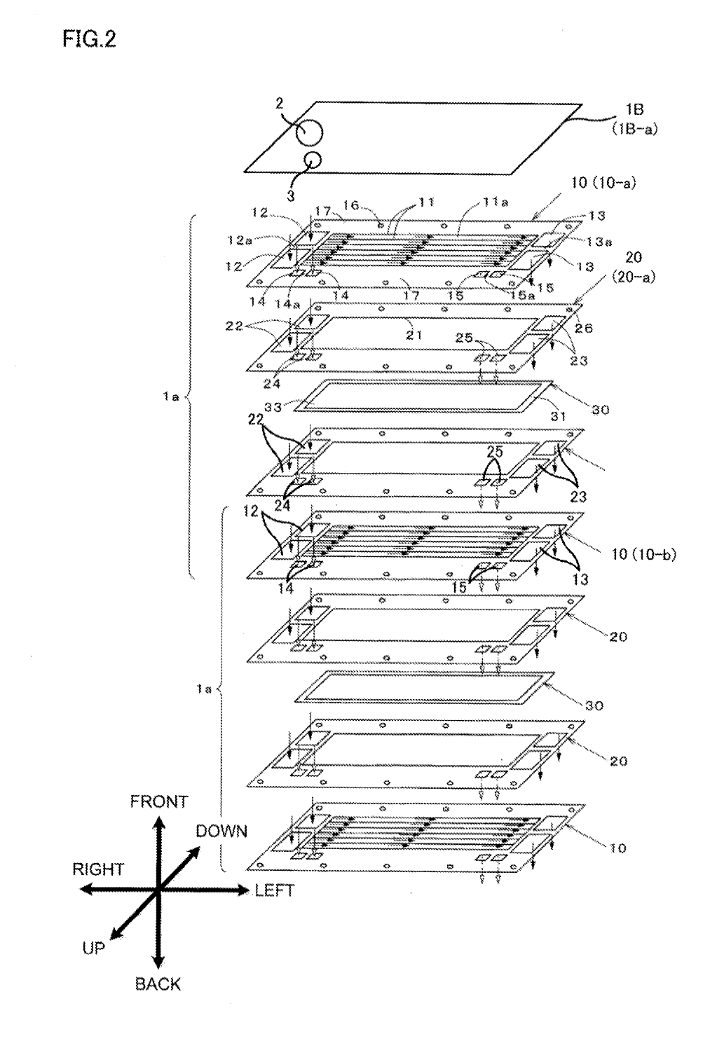

As shown in FIG. 2, each of the unit cells 1a comprises a membrane electrode assembly (MEA) 30, a pair of gaskets 20, and a pair of separators 10.

One gasket 20-a of the pair of gaskets 20 comes into contact with a front surface of the membrane electrode assembly 30, and another gasket 20-b of the pair of gaskets 20 comes into contact with a back surface of the membrane electrode assembly 30. The pair of separators 10 hold both surfaces of the membrane electrode assembly 30 that the gaskets 20 come into contact with, respectively. Hereinafter, the pair of separators 10, the pair of gaskets 20 and the membrane electrode assembly 30 of the polymer electrolyte fuel cell 1 shown in FIG. 2 will be sequentially described.

### <Membrane Electrode Assembly>

As shown in FIG. 2, the membrane electrode assembly 30 has a rectangular planer shape. The membrane electrode assembly 30 includes a solid polymer electrolyte membrane 31, a cathode electrode (not shown) and an anode electrode 33. The cathode electrode and the anode electrode 33 are provided on both surfaces of the solid polymer electrolyte membrane 31. Specifically, in FIG. 2, the anode electrode 33 is provided on the front surface of the membrane electrode assembly 30. Moreover, in FIG. 2, the cathode electrode (not shown) is provided on the back surface of the membrane electrode assembly 30. Each of the cathode electrode and the anode electrode 33 has a catalyst layer and a gas diffusion layer, which are not shown.

### <Gasket>

The gasket 20 is made of a rectangular sheet material. For example, an elastic body, such as rubber, an elastomer and the like, processed so as to have an extremely small thickness may be used as the sheet material that forms the gasket 20. The gasket 20 has a rectangular planer shape. The gasket 20 is formed with a first through-hole 21, second through-holes 22, third through-holes 23, fourth through-holes 24, fifth through-holes 25, and sixth through-holes 26. The first through-hole 21, the second through-holes 22, the third through-holes 23, the fourth through-holes 24, the fifth through-holes 25, and the sixth through-holes 26 are each a hole being pierced in the gasket 20 in the front-and-back direction.

The largest rectangular first through-hole 21 is formed in the center of the gasket 20. An outer shape of the first through-hole 21 in the gasket 20 corresponds to that of a substantially rectangular region where a plurality of first flow path walls 11 or a plurality of second flow path walls 19 of the separator 10, which will be described later, are formed. Moreover, a position of the first through-hole 21 in the gasket 20 corresponds to that of the substantially rectangular region where the plurality of the first flow path walls 11 or the plurality of second flow path walls 19 of the separator 10, which will be described later, are formed. In addition, the outer shape of the first through-hole 21 in the gasket 20 also corresponds to those of the cathode electrode (not shown) and the anode electrode 33 provided on both surfaces of the membrane electrode assembly 30. Moreover, the position of the first through-hole 21 in the gasket 20 corresponds to those of the cathode electrode (not shown) and the anode electrode 33 provided on both surfaces of the membrane electrode assembly 30.

In the embodiment, the first through-hole 21, the second through-holes 22, the third through-holes 23, the fourth through-holes 24, the fifth through-holes 25, and the sixth through-holes 26 are formed at different positions of the gasket 20, respectively. Specifically, in the example of FIG. 2, the two second through-holes 22 are formed along the upper-and-lower direction on a right end side of the gasket 20. Moreover, the two third through-holes 23 are formed along the upper-and-lower direction on a left end side of the gasket 20. In the embodiment, an outer shape and positions of the second through-holes 22 correspond to those of first holes 12 of the separator 10, which will be described later, respectively. Moreover, an outer shape and positions of the third through-holes 23 correspond to those of second holes 13 of the separator 10, which will be described later, respectively.

Furthermore, in the example of FIG. 2, the two fourth through-holes 24 are formed along the right-and-left direction on an upper end side of the gasket 20 and on the right end side of the gasket 20. Moreover, the two fifth through-holes 25 are formed along the right-and-left direction on the upper end side of the gasket 20 and on the left end side of the gasket 20. In the embodiment, an outer shape and positions of the fourth through-holes 24 correspond to those of third holes 14 of the separator 10, which will be described later, respectively. Moreover, an outer shape and positions of the fifth through-holes 25 correspond to those of fourth holes 15 of the separator 10, which will be described later, respectively.

The plurality of sixth through-holes 26 are formed in the vicinity of respective long sides of the rectangle of the gasket 20. In the example of FIG. 2, the plurality of sixth through-holes 26 are formed at regular intervals in the gasket 20. In the example of FIG. 2, the plurality of sixth through-holes 26 along the long side in the upper direction are formed on an outer side of the gasket 20 with respect to the fourth through-holes 24 and the fifth through-holes 25. An outer shape and positions of the plurality of sixth through-holes 26 correspond to those of a plurality of insertion holes 16 of the separator 10, which will be described later, respectively.

### <Separator>

The separator 10 is made of a rectangular metal plate. For example, the separator 10 is produced, using aluminum. The separator 10 may be produced, using carbon or stainless steel. In the embodiment, carbon is applied onto aluminum. The separator 10 has a rectangular planar shape of almost the same dimensions as those of the gasket 20 or the end plate 1B. The separator 10 is formed with the plurality of first flow path walls 11, the first holes 12, the second holes 13, the third holes 14, the fourth holes 15, and the insertion holes 16 (fifth holes, sixth holes). The first holes 12, the second holes 13, the third holes 14, the fourth holes 15, and the insertion holes 16 are each a through-hole being pierced in the separator in the front-and-back direction.

In the embodiment, the first holes 12, the second holes 13, the third holes 14, the fourth holes 15, and the insertion holes 16 are formed at different positions of the separator 10, respectively. Specifically, in the example of FIG. 2, the two first holes 12 are formed along the upper-and-lower direction on a right end side of the separator 10. Moreover, the two second holes 13 are formed along the upper-and-lower direction on a left end side of the separator 10. Furthermore, in the example of FIG. 2, the two third holes 14 are formed along the right-and-left direction on an upper end side of the separator 10, and on the right end side of the separator 10. In addition, the two fourth holes 15 are formed along the right-and-left direction on the upper end side of the separator 10, and on the left end side of the separator 10. The two first holes 12 in the separator 10 are formed at a position corresponding to the first gas hole 2 in the end plate 1B-a. Moreover, the two third holes 14 in the separator 10 are formed at a position corresponding to the second gas hole 3 in the end plate 1B-a.

The plurality of first flow path walls 11 are provided at the center of the front surface of the separator 10 shown in FIG. 2 at predetermined distances in parallel to each other. As shown in FIG. 2, the first flow path walls 11 each include a first groove portion 11a extending from a vicinity of the two first holes 12 to a vicinity of the two second holes 13 along the right-and-left direction. The first groove portion 11a is formed by extending a depressed portion, which is depressed from a planar surface of the separator 10, from the vicinity of the two first holes 12 to the vicinity of the two second holes 13. The first groove portions 11a shown in FIG. 2 may be each constituted by continuously forming a protrusion, which is protruded from the planar surface of the separator 10. The outer shape and position of the substantially rectangular region including the plurality of first flow path walls 11 corresponds to an outer shape and a position of the cathode electrode (not shown) provided on the back surface of the membrane electrode assembly 30.

In the example of FIG. 2, the oxidizing gas flowing in from the first gas hole 2 passes through the two first holes 12 of the separator 10, and further passes through the second through-holes 22 of the gasket 20. In the embodiment, the oxidizing gas is air existing outside the polymer electrolyte fuel cell 1. As the oxidizing gas, a gas including oxygen (O₂) may be employed. Moreover, the oxidizing gas (a first medium) flowing in from the first gas hole 2 flows from the two first holes 12 to the two second holes 13 along the first groove portions 11a of the respective first flow path walls 11. When the gasket 20 is disposed in the front direction of the plurality of first flow path walls 11, the cathode electrode of the membrane electrode assembly 30 and the plurality of first flow path walls 11 of a separator 10-b come into contact with each other through the first through-hole 21 of the gasket 20. Accordingly, the oxidizing gas can flow along the first groove portions 11a of the respective first flow path walls 11. This allows the oxidizing gas to be supplied to the cathode electrode of the membrane electrode assembly 30. The first flow path walls 11 are each, for example, a straight type flow path wall. In the embodiment, as shown in FIG. 2, the two first holes 12 are partitioned by a partition wall 12a. Also, the two second holes 13 are partitioned by a partition wall 13a. Moreover, the two third holes 14 are partitioned by a partition wall 14a. Also, the two fourth holes 15 are partitioned by a partition wall 15a. The two first holes 12, the two second holes 13, the two third holes 14, and the two fourth holes 15 may be each one rectangular hole resulting from joining the respective two holes. In the embodiment, in order to increase strength of the separator 10, the partition walls 12a, 13a, 14a, 15a each serving as a beam are provided between the respective two holes.

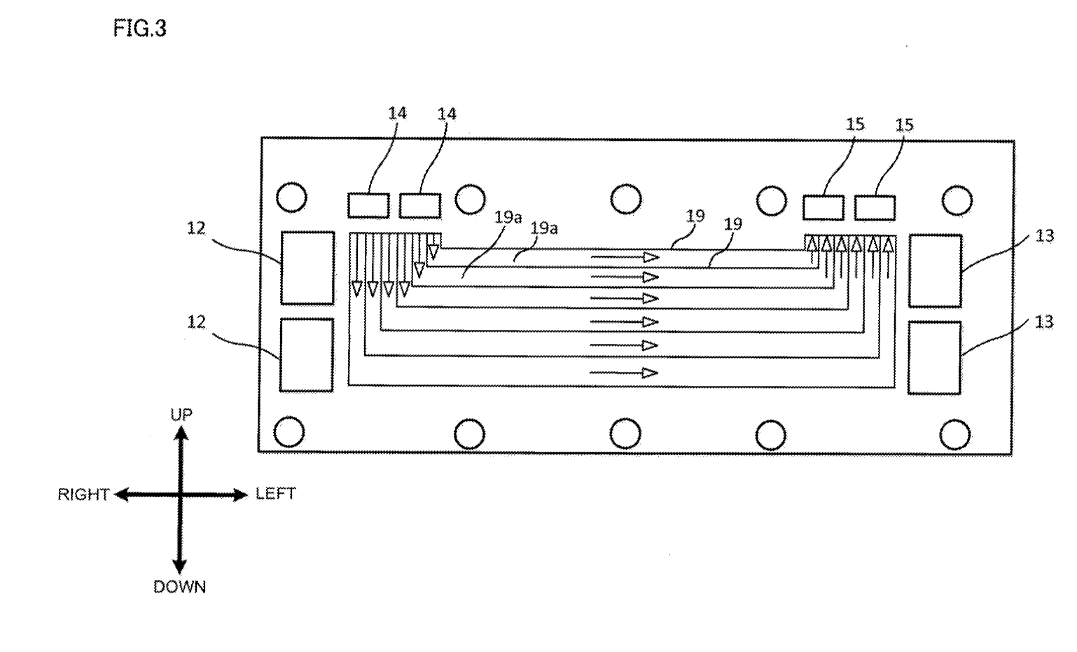

As shown in FIG. 3, the plurality of second flow path walls 19 are formed on the surface opposite to the surface where the first flow path walls 11 of the separator 10 are formed. The plurality of second flow path walls 19 are formed at predetermined distances side by side on the back surface of the separator 10 shown in FIG. 3. As shown in FIG. 3, the second flow path walls 19 each include a second groove portion 19a extending from a vicinity of the two third holes 14 along the upper-and-lower direction. The second groove portion 19a of each of the second flow path walls 19 extends along the right-and-left direction, and further extends toward the two fourth holes 15 along the upper-and-lower direction. The second groove portions 19a shown in FIG. 3 are each constituted by continuously forming a depressed portion, which is depressed from the planar surface of the separator 10. The second groove portions 19a shown in FIG. 3 may be each constituted by continuously forming a protrusion, which is protruded from the planar surface of the separator 10. The outer shape and position of the region including the plurality of second flow path walls 19 correspond to an outer shape and a position of the anode electrode 33 provided on the front surface of the membrane electrode assembly 30. The second flow path walls 19, which are different from the straight type first flow path walls 11, are each a serpentine type flow path wall, in which both ends of the second flow path wall 19 along the right-and-left direction are bent at a right angle toward the third hole 14 and the fourth hole 15, respectively.

In the example of FIG. 3, the fuel gas flowing in from the second gas hole 3 passes through the two third holes 14 of the separator 10. In the embodiment, the fuel gas is hydrogen (H₂). As the fuel gas, a gas including hydrogen (H₂) may be employed. The fuel gas (a second medium), which has passed through the two third holes 14, passes through the fourth through-holes 24 of the gasket 20-a. Furthermore, the fuel gas, which has passed through the two third holes 14, flows from the two third holes 14 to the two fourth holes 15 along the second groove portions 19a of the respective second flow path walls 19 in FIG. 3. Particularly, the anode electrode 33 of the membrane electrode assembly 30 comes into contact with the plurality of second flow path walls 19 of a separator 10-a through the first through-hole 21 of the gasket 20-a. Accordingly, the fuel gas can flow along the second groove portions 19a of the respective second flow path walls 19. This allows the fuel gas to be supplied to the anode electrode 33 of the membrane electrode assembly 30.

Furthermore, in the vicinity of respective long sides of a rectangle of the separator 10, the plurality of insertion holes 16 are formed. In the example of FIG. 2, the plurality of insertion holes 16 are formed at regular intervals in the separator 10. In the embodiment, in order to increase strength of the separator 10, the third holes 14 and the fourth holes 15 are formed in regions between the adjacent two insertion holes 16, respectively.

The plurality of bolts 1C are inserted into the plurality of insertion holes 16, respectively. A diameter of the insertion holes 16 is larger than a diameter of the bolts 1C by 3 mm or more. When each of the bolts 1C is inserted into each of the insertion holes 16, a clearance of 1.5 mm or more is formed between the insertion hole 16 and the bolt 1C. As a result, the separator 10 and the bolts 1C are securely insulated.

A distance between the adjacent insertion holes 16 along each of the long sides of the separator 10 is 80 mm or less. When the distance between the insertion holes 16 is 80 mm or less, the sealability between the separator 10 and the gasket 20 is increased, and particularly, leakage of the fuel gas is effectively prevented. Preferably, the distance between the insertion holes 16 is about 60 mm±1 mm.

Here, the polymer electrolyte fuel cell 1 of the embodiment is of an air cooling type. In the polymer electrolyte fuel cell 1 of the embodiment, regions between the long sides of the rectangle of the separator 10, and both ends of the plurality of the first flow path walls 11 in the upper-and-lower direction are each a heat radiation unit 17. As shown in FIG. 1, when the plurality of unit cells 1a are stacked, the heat radiation units 17 of the respective separators 10 form a plurality of fins and a wide heat radiation area is provided. The polymer electrolyte fuel cell 1 is, for example, a fuel cell including the solid polymer electrolyte membrane 31. The polymer electrolyte fuel cell 1 may be a general fuel cell. The general fuel cell is, for example, a fuel cell using a membrane other than the solid polymer electrolyte membrane 31.

### <Principle of Power Generation>

As described above, the fuel gas is supplied to the anode electrode 33 of the membrane electrode assembly 30. The fuel gas is supplied along the plurality of the second flow path walls 19 of the separator 10, and is diffused by the diffusion layer of the anode electrode 33. The fuel gas is decomposed into a hydrogen ion and an electron by the catalyst layer. The hydrogen ion passes through the solid polymer electrolyte membrane 31, and moves to the cathode electrode. The electron passes through the separator 10, which is a conductor, and moves to the cathode electrode. In the cathode electrode, as described above, the oxidizing gas flowing along the plurality of first flow path walls 11, and the moved hydrogen ion and electron are reacted at the catalyst layer to generate water. Here, electricity is generated by the reverse principle of electrolysis of water. The generated water and/or gas flow along the plurality of the first flow path walls 11 and pass through the second holes 13. Moreover, the water and/or gas generated in the membrane electrode assembly 30 pass through the fourth holes 15.

### <Assembly of Stack>

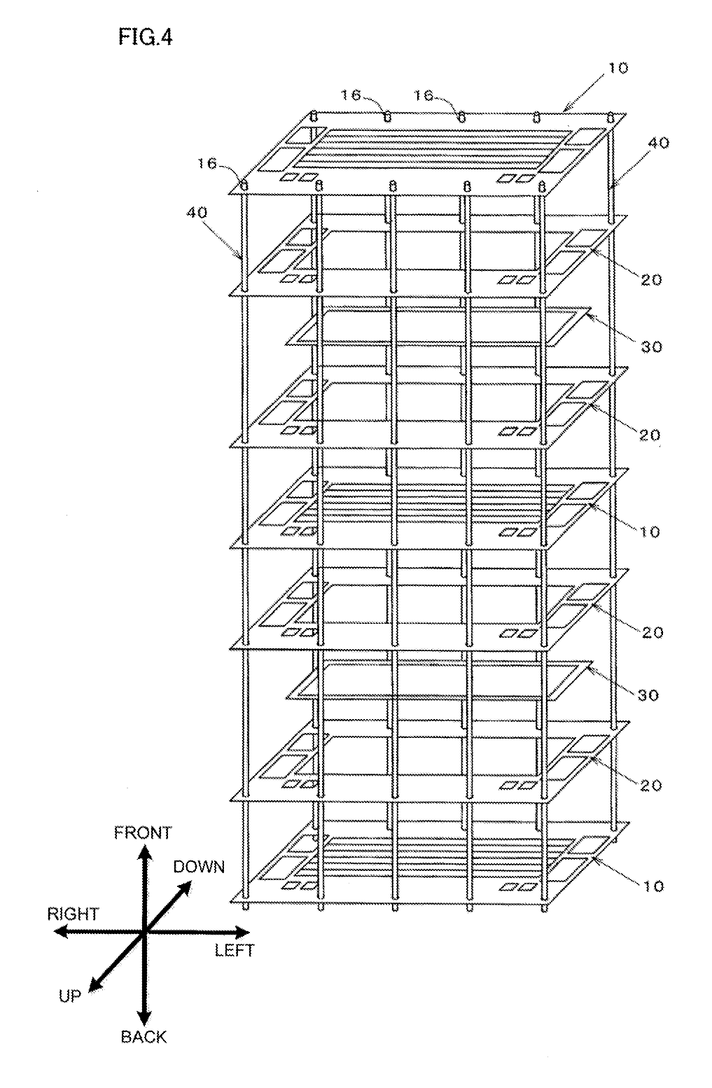

As shown in FIG. 4, in assembling the stack 1A, a plurality of assembling shafts 40 are used to position the separators 10 and the gaskets 20. The plurality of assembling shafts 40 are disposed at the same positions of the insertion holes 16 of the separators 10 and the sixth through-holes 26 of the gaskets 20 and provided on a base not shown. The assembling shafts 40 are inserted into the insertion holes 16 and the sixth through-holes 26, respectively. It is to be noted that a diameter of the assembling shafts 40, which is different from a diameter of the bolts 1C, is substantially equal to the diameter of the insertion holes 16 of the separators 10 and the sixth through-holes 26 of the gaskets 20. More specifically, in consideration of difference in the diameter or the position due to manufacturing error, the diameters of the insertion holes 16 of the separators 10 and the sixth through-holes 26 of the gaskets 20 are set to be slightly (for example, about several %) larger than that of the assembling shafts 40. As an example, the diameter of the assembling shafts 40 is 8 mm, and the diameter of the sixth through-holes 26 of the gaskets 20 is 8.35 mm.

The stack 1A is assembled by sequentially stacking the separators 10, the gaskets 20, and the membrane electrode assemblies 30. When the separator 10 and the gasket 20 are stacked, the assembling shafts 40 are inserted into the insertion holes 16 and the sixth through-holes 26. Since the diameter of the assembling shafts 40 is substantially equal to the diameters of the insertion holes 16 of the separator 10 and the sixth through-holes 26 of the gasket 20, the separator 10 and the gasket 20 are precisely positioned.

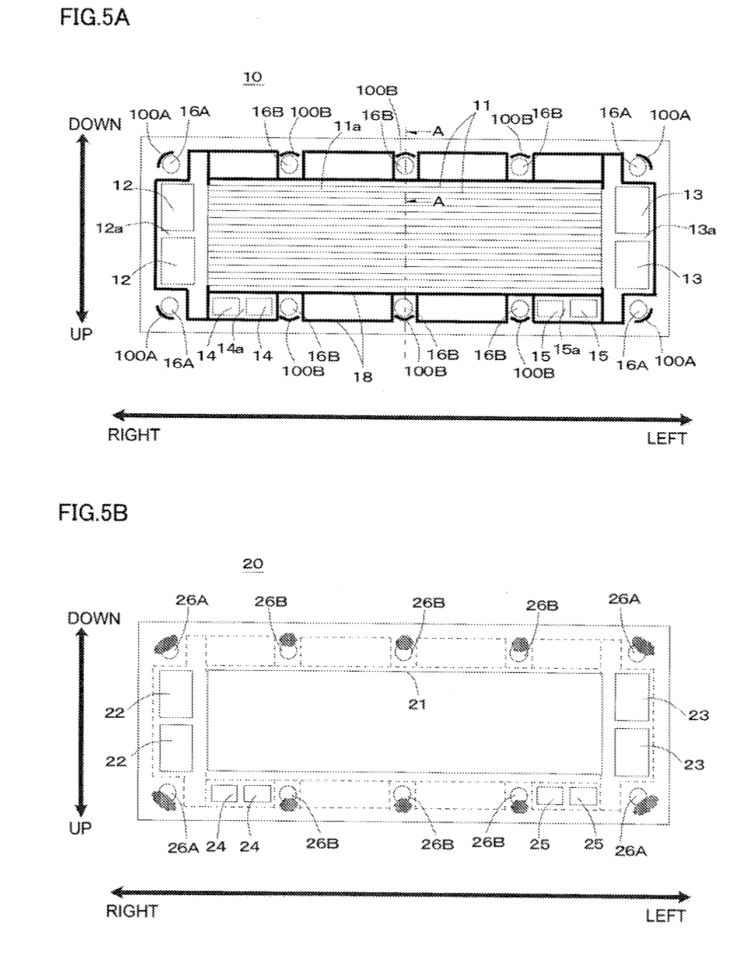

When all of the separators 10, the gaskets 20 and the membrane electrode assemblies 30 are completely stacked, a load is applied to these component parts, and the plurality of assembling shafts 40 are pulled out of the insertion holes 16 and the sixth through-holes 26. Applying the load to the plurality of separators 10 and the plurality of gaskets 20 completely stacked deforms the pair of gaskets 20 provided between the pair of separators 10 to seal the pair of separators 10. This can prevent the oxidizing gas and the fuel gas flowing into the membrane electrode assembly 30 from leaking outside the separator 10. In order to seal the pair of separators 10, using the gaskets 20, the separator 10 is formed with gasket lines 18. Hereinafter, referring to FIGS. 5A and 5B, details of the gasket lines 18 will be described.

### <Gasket Line 18>

Referring to FIG. 5A, details of the gasket line 18 formed on a front surface of the separator 10 will be described. A straight bold line of FIG. 5A represents the gasket line 18. The gasket line 18 is a protrusion formed continuously on the front surface of the separator 10. The gasket line 18 of the embodiment is formed integrally with the separator 10, using the same material as that of the separator 10. The gasket line 18 may be formed, using a different material from that of the separator 10. Moreover, in place of being formed integrally with the separator 10, the gasket line 18 may be formed separately from the separator 10. The gasket line 18 (a first protrusion portion) continuously encompasses the plurality of first flow path walls 11 (the first groove portions 11a), the two first holes 12, the two second holes 13, the two third holes 14, and the two fourth holes 15. That is, as the gasket line 18, the continuous protrusion surrounding the plurality of first flow path walls 11, the two first holes 12, the two second holes 13, the two third holes 14, and the two fourth holes 15 is formed in the separator 10. In the embodiment, as shown in FIG. 5A, the gasket line 18 (the first protrusion portion) is formed in the separator 10 so as to surround the plurality of first flow path walls 11 (the first groove portions 11a), the two first holes 12, and the two second holes 13. Moreover, the gasket line 18 is formed in the separator 10 so as to surround the two third holes 14. Also, the gasket line 18 is formed in the separator 10 so as to surround the two fourth holes 15. Furthermore, the gasket line 18 is also formed between the respective insertion holes 16. In the embodiment, the plurality of insertion holes 16 are formed outside the gasket line 18. Specifically, the plurality of insertion holes 16 are each formed between the gasket line 18 and an outer edge of the separator 10. Moreover, in the embodiment, a thickness in the front-and-back direction of the gasket 20 is larger than that of the protrusion constituting the gasket line 18.

The gasket line 18 comes in contact with the surface of the gasket 20 when the separator 10 and the gasket 20 are stacked. Accordingly, the plurality of first flow path walls 11, the two first holes 12, the two second holes 13, the two third holes 14, and the two fourth holes 15 encompassed by the gasket line 18 are sealed by the gasket 20. The plurality of first flow path walls 11, the two first holes 12, the two second holes 13, the two third holes 14, and the two fourth holes 15 are sealed by the gasket 20, which prevents the oxidizing gas and the fuel gas from leaking outside.

A dotted line of FIG. 5B represents a contact portion where the gasket 20 comes in contact with the gasket line 18 of the separator 10. When the separator 10 and the gasket 20 are stacked, the portions of the gasket 20 indicated by the dotted line are pressed by the gasket line 18.

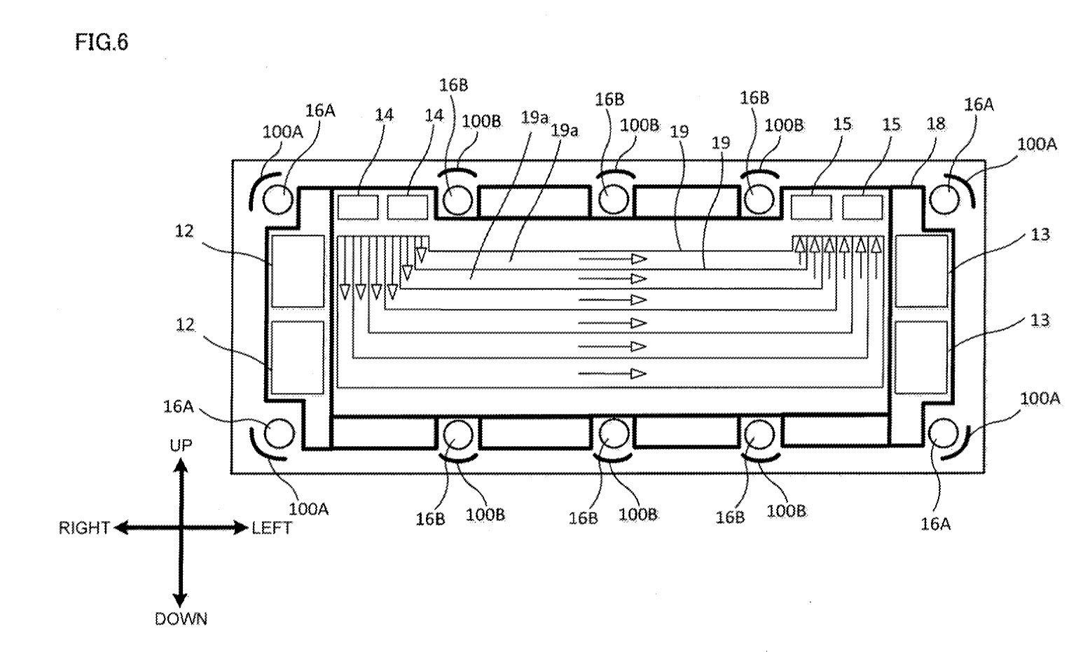

Referring to FIG. 6, details of the gasket line 18 formed on the back surface of the separator 10 will be described. A straight bold line of FIG. 6 represents the gasket line 18. The gasket line 18 is a protrusion formed continuously on the back surface of the separator 10. The gasket line 18 (a second protrusion portion) continuously encompasses the plurality of second flow path walls 19 (the second groove portions 19a), the two first holes 12, the two second holes 13, the two third holes 14, and the two fourth holes 15. That is, as the gasket line 18, the continuous protrusion surrounding the plurality of second flow path walls 19, the two first holes 12, the two second holes 13, the two third holes 14, and the two fourth holes 15 is formed in the separator 10. In the embodiment, as shown in FIG. 6, the gasket line 18 (the second protrusion portion) is formed in the separator 10 so as to surround the plurality of second flow path walls 19 (the second groove portions 19a), the two third holes 14, and the two fourth holes 15. Moreover, the gasket line 18 is formed in the separator 10 so as to surround the two first holes 12. Also, the gasket line 18 is formed in the separator 10 so as to surround the two second holes 13. Furthermore, the gasket line 18 is also formed between the respective insertion holes 16. In the embodiment, the plurality of insertion holes 16 are formed outside the gasket line 18. Specifically, the plurality of insertion holes 16 are each formed between the gasket line 18 and the outer edge of the separator 10.

Meanwhile, after the separator 10 and the gasket 20 are stacked, an outer portion of the gasket 20 with respect to the dotted line becomes freely expandable and contractible. In regions where the plurality of sixth through-holes 26A, 26B of the gasket 20, and the contact portion between the gasket line 18 and the gasket 20 are adjacent to each other as shown in FIG. 5B, the expansion and contraction of the gasket 20 can be prevented. Shaded regions of the plurality of sixth through-holes 26A, 26B of the gasket 20 surrounded by the dotted line as shown in FIG. 5B, being away from the contact portion between the gasket line 18 and the gasket 20, can be expanded or contracted freely. Particularly, the shaded regions of the plurality of sixth through-holes 26A of the gasket 20 surrounded by the dotted line as shown in FIG. 5B, which are away from the contact portion between the gasket line 18 and the gasket 20, are larger. Thus, these regions may be expanded and contracted more freely than the regions where the sixth through-holes 28B of the gasket 20 are formed. There is a possibility that the gasket 20 in the above-described shaded regions of the sixth through-holes 26A, 26B surrounded by the dotted line sticks to the assembling shaft 40. At this time, conventionally, there has been a problem that since a part of the gasket 20 sticks to the assembling shaft 40 when the assembling shafts 40 are pulled out, the gasket 20 is damaged and the sealability between the pair of the separators 10 is impaired.

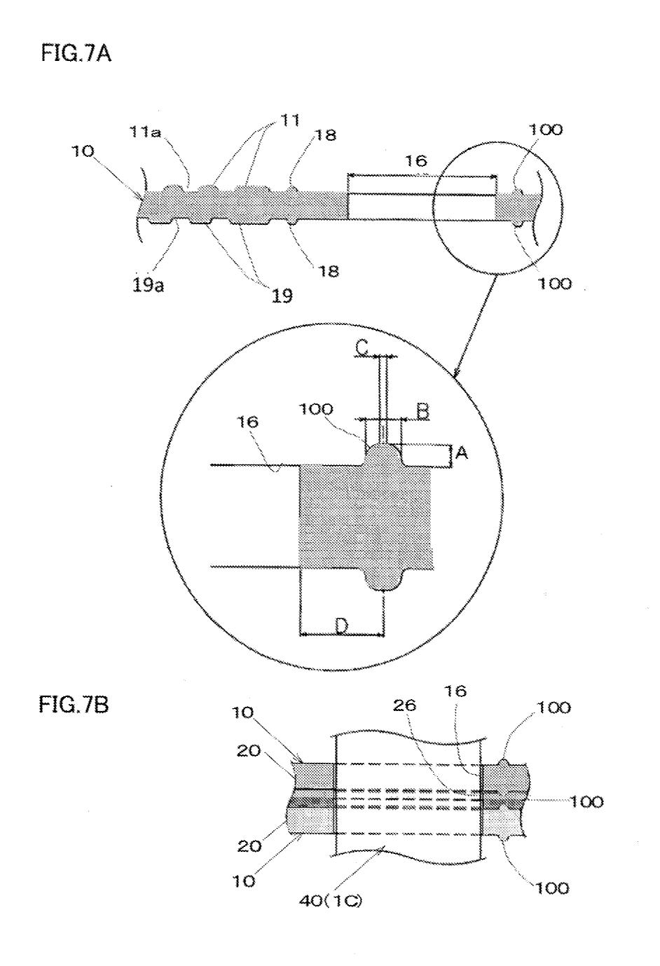

In order to solve the above-described problem, the separator 10 of the embodiment is formed with protrusions 100A, 100B shown in FIG. 5A in peripheral regions of the respective insertion holes 16. Hereinafter, the protrusions 100A, 100B formed in the separator 10 of the embodiment will be described in detail with reference to FIGS. 5A and 5B and FIGS. 7A and 7B.

### <Protrusion>

As shown in FIGS. 5A and 5B and FIGS. 7A and 7B, the protrusions 100A, 100B (third protrusion portions, fourth protrusion portions) are formed integrally with the separator 10, using the same material as that of the separator 10. The protrusions 100A, 100B may be formed, using a different material from that of the separator 10. Moreover, in place of being formed integrally with the separator 10, the protrusions 100A, 100B may be formed separately from the separator 10, respectively.

The separator 10 of the embodiment is formed with the protrusions 100A, 110B in the peripheral regions of the respective insertion holes 16A, 16B, respectively. The protrusions 100A, 100B each have a protruded shape. Specifically, the protrusions 110A are each formed between the gasket line 18 and an outer edge portion (a corner portion) of the separator 10. That is, each of the protrusions 100A is formed between the insertion hole 16A and the outer edge portion (the corner portion) of the separator 10. Moreover, the protrusions 100B are each formed between the gasket line 18 and the outer edge portion of the separator 10. That is, each of the protrusions 100B is formed between the insertion hole 16B and the outer edge portion of the separator 10.

A shape of the protrusion 100A in the embodiment is an arc corresponding to ¼ of a circle provided between the insertion hole 16A and the corner portion of the separator 10. Moreover, a shape of the protrusion 100B is an are corresponding to ¼ of a circle provided between the insertion hole 16B and the outer edge of the separator 10. The protrusion 100A is formed along a part of an outer edge of the circular shape of the insertion hole 16A. Moreover, the protrusion 100B is formed along a part of an outer edge of the circular shape of the insertion hole 16B. The protrusion 100A is formed at a predetermined distance from the outer edge of the circular shape of the insertion hole 16A. Also, the protrusion 100B is formed at a predetermined distance from the outer edge of the circular shape of the insertion hole 16B.

In the embodiment, the protrusions 100A and 100B are formed in line symmetry in the right-and-left direction with respect to a centerline A of the long sides of the separator 10 indicated by a chain line in FIG. 5A. The protrusions 100A formed at both ends of the long sides of the separator 10 are inclined at an angle of ±45° with respect to the protrusions 100B formed along the long sides of the separator 10. Since for each of the insertion holes 16B, only at a portion adjacent to the long side of the separator 10, the gasket line 18 is not formed, the protrusion 100B is formed on a side of the long side of the separator 10 around the insertion hole 16B. On the other hand, for each of the insertion holes 16A, since the gasket line 18 is not formed at a portion adjacent to both the long side and a short side of the separator 10, the protrusion 100A is formed across the side of the long side and a side of the short side of the separator 10 around the insertion hole 16A.

Next, a structure of the protrusions of the embodiment will be described in more detail with reference to FIGS. 7A and 7B. In the following description, a “protrusion 100” represents both the above-described protrusions 100A, 100B. Moreover, an “insertion hole 16” represents both the above-described insertion holes 16A, 16B.

As shown in FIG. 7A, on both surfaces of the separator 10 of the embodiment along the right-and-left direction are formed the plurality of first flow path walls 11 and the plurality of second flow path walls 19, and the gasket lines 18 surrounding the first flow path walls 11 and the second flow path walls 19, respectively. Moreover, outside the gasket lines 18 on both surfaces along the right-and-left direction of the separator 10 are formed the plurality of insertion holes 16 and the protrusions 100.

As shown in FIGS. 7A and 7B, a height A of the protrusion 100 is set to such a dimension as not to hinder the plurality of first flow path walls 11 from coming in contact with the membrane electrode assembly 30. In addition, the height A of the protrusion 100 is set to such a dimension as to reduce 10 to 40% of the thickness of the gasket 20 when the stacked body of the unit cells 1a is fastened by the bolts 1C. As the protrusions 100 reduce 10 to 40% of the thickness of the gasket 20, the gasket 20 can be sufficiently pressed. As a result, the gasket 20 can be prevented from sticking to the assembling shafts 40. Further, the thickness in the front-and-back direction of the gasket 20 is larger than the height A of the protrusion 100. The height A of the protrusion 100 and a height of the gasket line 18 in the front-and-back direction may be the same. Moreover, the height A of the protrusion 100 may be set so that a clearance of 0.5 mm or less is formed between the separator 10 and the gasket 20. Forming this clearance of 0.5 mm or less can prevent the separator 10 from pressing the gasket 20.

A flat surface C having a width of 0.1 mm or more may be formed at a top portion of the protrusion 100. If the top portion of the protrusion 100 is sharp, there is a possibility that the gasket 20 is broken by the top portion. As the flat surface C of a width of 0.1 mm or more is formed at the top portion of the protrusion 100, breakage of the gasket 20 is prevented.

A distance D of 2 mm or more may be formed from the center of the protrusion 100 to the outer edge of the insertion hole 16.

While in the embodiment, the gasket lines 18 and the protrusions 100 are formed in the separator 10, the present disclosure is not limited to this structure. The above-described gasket line 18 and/or the protrusions 100 may be formed in at least one of the separator 10 and the gasket 20. At least one of the gasket line 18 and the protrusions 100 may be formed in the gasket 20.

### <Variation of Protrusion>

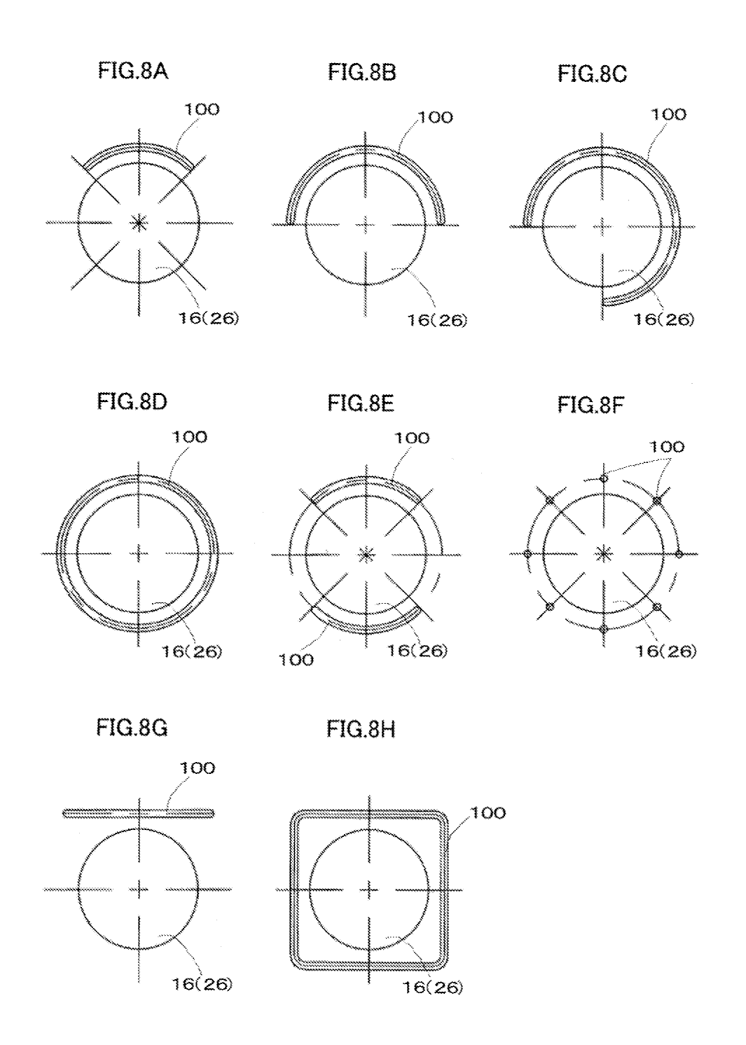

The protrusion 100 shown in FIG. 8A can be modified, for example, in various shapes shown in FIGS. 8B to 8H according to the shape of the gasket line 18 formed in the vicinity of each of the insertion holes 16.

As an extent to which the outer edge of the insertion hole 16 and the gasket line 18 are within a predetermined distance from each other is reduced, an extent to which the protrusion 100 is formed along the insertion hole 16 is increased. In this case, for example, as shown in FIGS. 8B and 8C, the shape of the protrusion 100 may be an arc corresponding to ½ of a circle or an arc corresponding to ¾ of a circle. When the extent to which the insertion hole 16 and the gasket line 18 are within the predetermined distance from each other is zero, for example, as shown in FIG. 8D, the shape of the protrusion 100 may be a circle completely surrounding the insertion hole 16.

As shown in FIG. 8E, a plurality of arc-shaped protrusions 100 may be formed with respect to one of the insertion holes 16. The shape of the protrusion 100 is not limited to an are or a circle, but for example, may be a dot shape shown in FIG. 8F. Also, the shape of the protrusion 100 may be a linear shape shown in FIG. 8G. The shape of the protrusion 100 may be a quadrangular shape shown in FIG. 8H.

### <Effects>

According to the polymer electrolyte fuel cell 1, and the separator 10 and the gasket 20 that constitute the same in the embodiment, it is possible to securely prevent the gasket 20 from sticking to the assembling shaft 40, and to improve sealability of the stack 1A.

### <Other Modifications>

The separator 10 and the polymer electrolyte fuel cell including the same in the embodiment are not limited to the structures of the above-described embodiment. For example, while in the above-described embodiment, the outer shape of the separator 10 is a substantially rectangular shape having long sides and short sides, the outer shape of the separator 10 is not particularly limited, but may be modified into an arbitrary shape.

In addition, for example, in the above-described embodiment, while the plurality of first flow path walls 11 of the oxidizing gas are of a straight type and the plurality of second flow path walls 19 of the fuel gas are of a serpentine type, the structures are not particularly limited thereto either. A design of the plurality of first flow path walls 11 may be changed as long as the gas flows from the first holes 12 to the second holes 13. Likewise, a design of the plurality of second flow path walls 19 may be changed as long as the gas flows from the third holes 14 to the fourth holes 15. In addition, the positions of the first holes 12, the second holes 13, the third holes 14 and the fourth holes 15 are not limited to the positions of the above-described embodiment, either. Furthermore, the partition walls 12a, 13a, 14a, 15a for reinforcement may be omitted, and each of the first holes 12, the second holes 13, the third holes 14, and the fourth holes 15 may be formed as one hole.

Furthermore, although the air-cooling type separator 10 has been exemplified in the embodiment, the protrusions 100A or the protrusions 100B can be applied to a water-cooling type separator including a hole through which cooling water passes.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A fuel cell comprising:
a membrane electrode assembly having a planar shape;
a separator having a planar shape and provided on each of both surfaces of the membrane electrode assembly, the separator comprising:
a first groove portion formed between a first hole being pierced in the separator and a second hole being pierced in the separator on a first surface of the separator;
a second groove portion formed between a third hole being pierced in the separator and a fourth hole being pierced in the separator on a second surface of the separator;
a first protrusion portion formed on the first surface, the first protrusion portion surrounding the first groove portion, the first hole, the second hole, the third hole, and the fourth hole;
a second protrusion portion formed on the second surface, the second protrusion portion surrounding the second groove portion, the first hole, the second hole, the third hole, and the fourth hole; and
a plurality of third protrusion portions formed between a plurality of fifth holes and an edge of the separator on each of the first surface and the second surface, the plurality of fifth holes being pierced in the separator between the edge of the separator and an area, the area corresponding to a region surrounded by the first protrusion portion on the separator and a region surrounded by the second protrusion portion on the separator; and
a gasket provided between the membrane electrode assembly and the separator, the gasket being formed with a through-hole being pierced in the gasket at a position corresponding to the first groove portion and the second groove portion, and through-holes being pierced in the gasket at positions corresponding to the first hole, the second hole, the third hole, the fourth hole, and the plurality of fifth holes, respectively.

2. The fuel cell according to claim 1, wherein the plurality of third protrusion portions are each formed along a part of a periphery of each of the plurality of fifth holes.

3. The fuel cell according to claim 1, wherein a plane is formed at a top portion of each of the plurality of third protrusion portions.

4. The fuel cell according to claim 1, wherein in the separator, the first protrusion portion and the second protrusion portion are further formed between the plurality of fifth holes, respectively.

5. The fuel cell according to claim 1, wherein each of the plurality of fifth holes is configured to allow an assembling shaft to be inserted thereinto.

6. The fuel cell according to claim 1, wherein
the membrane electrode assembly comprises:
a first electrode opposed to the first surface of the separator; and
a second electrode opposed to the second surface of the separator,
the first groove portion is for flowing a first medium supplied from the first hole to the first electrode, and
the second groove portion is for flowing a second medium supplied from the third hole to the second electrode.

7. The fuel cell according to claim 6, wherein
the first groove portion is for flowing the first medium including oxygen to a cathode electrode as the first electrode, and
the second groove portion is for flowing the second medium including hydrogen to an anode electrode as the second electrode.

8. A separator having a planar shape to be provided on each of both surfaces of a membrane electrode assembly having a planar shape, the separator comprising:
a first groove portion formed between a first hole being pierced in the separator and a second hole being pierced in the separator on a first surface of the separator;
a second groove portion formed between a third hole being pierced in the separator and a fourth hole being pierced in the separator on a second surface of the separator;
a first protrusion portion formed on the first surface, the first protrusion portion surrounding the first groove portion, the first hole, the second hole, the third hole, and the fourth hole;
a second protrusion portion formed on the second surface, the second protrusion portion surrounding the second groove portion, the first hole, the second hole, the third hole, and the fourth hole; and
a plurality of third protrusion portions formed between a plurality of fifth holes and an edge of the separator on each of the first surface and the second surface, the plurality of fifth holes being pierced in the separator between the edge of the separator and an area, the area corresponding to a region surrounded by the first protrusion portion on the separator and a region surrounded by the second protrusion portion on the separator.

9. A fuel cell comprising:
a membrane electrode assembly having a planar shape;
a first separator having a planar shape and provided on one surface of the membrane electrode assembly, the first separator comprising:
a first groove portion formed between a first hole being pierced in the first separator and a second hole being pierced in the first separator on a first surface opposed to the membrane electrode assembly; and
a first protrusion portion formed on the first surface, the first protrusion portion surrounding the first groove portion, the first hole, and the second hole; and
a second separator having a planar shape and provided on another surface of the membrane electrode assembly, the second separator comprising:
a second groove portion formed between a third hole being pierced in the second separator and a fourth hole being pierced in the second separator on a second surface opposed to the membrane electrode assembly; and
a second protrusion portion formed on the second surface, the second protrusion portion surrounding the second groove portion, the third hole, and the fourth hole,
wherein the first separator comprises a plurality of third protrusion portions formed between a plurality of fifth holes and an edge of the first separator on the first surface, the plurality of fifth holes being pierced in the first separator between the edge of the first separator and a region surrounded by the first protrusion portion,
the second separator comprises a plurality of fourth protrusion portions formed between a plurality of sixth holes and an edge of the second separator on the second surface, the plurality of sixth holes being pierced in the second separator between the edge of the second separator and a region surrounded by the second protrusion portion, and
the fuel cell further comprises:
a first gasket provided between the membrane electrode assembly and the first separator, the first gasket being formed with through-holes being pierced in the first gasket at positions corresponding to the first groove portion, the first hole, the second hole, and the plurality of fifth holes, respectively; and
a second gasket provided between the membrane electrode assembly and the second separator, the second gasket being formed with through-holes being pierced in the second gasket at positions corresponding to the second groove portion, the third hole, the fourth hole, and the plurality of sixth holes, respectively.
